(19) United States
(12) Patent Application Publication
(10) Pub. No.: US 2001/0049760 A1
(43) Pub. Date: Dec. 6, 2001

(54) Redundant bus controller for bus with several masters

(76) Inventor: Hugo Delchini, Paris (FR)

Correspondence Address: Robert W. Bergstrom, Summit Law Group PLLC, 1505 Westlake Ave. N., Suite 300, Seattle, WA, 98109, US

(21) Appl. No.: 09/726,849

(22) Filed: Nov. 30, 2000

(30) Foreign Application Priority Data
May 31, 2000 (FR) FR0007028

(51) Int. Cl. G06F 13/00

(52) U.S. Cl. 710/110

(57) ABSTRACT

The invention relates to a bus controller for a bus (7) which can be used by several masters, characterized in that it comprises at least two modules (7a, 7b) each of which contains an arbiter and an arbiter supervisor, the function of one at least of the arbiter supervisors being to enable the output of the arbiter of the same module as long as it observes that this arbiter is operating correctly and to disable this output when it observes that the arbiter of the same module is not operating correctly.

The present invention relates to a redundant bus controller for a bus which can be used by several masters.

It is known that buses which can be accessed by several masters are managed by arbiters which successively grant access authorizations to the various masters, following access requests issued by these masters.

In the event of a conflict between two masters simultaneously requesting access to the bus, the arbiter grants access to the master possessing the highest priority, by applying a particular algorithm for managing priorities.

An exemplary bus which can be accessed by several masters is that of a cluster of computers linked by this bus. The computers of the cluster communicate with one another via the bus, either directly, or by way of a local network simulation using the physical structure of the bus.

In such clusters, it is vital for the arbiter to operate in a reliable and dependable manner, otherwise the entire cluster, that is to say each of the computers of which it is composed, will be out of service.

The present invention aims to provide a fault tolerant bus controller exhibiting a high level of reliability.

Furthermore, in a particular version, the bus controller according to the invention is able to ensure continuity of operation of the bus, including during the phases of maintenance of the said controller.

The subject of the present invention is a bus controller characterized in that it comprises at least two modules each of which contains an arbiter and an arbiter supervisor, the function of one at least of the arbiter supervisors being to enable the output of the arbiter of the same module as long as it observes that this arbiter is operating correctly and to disable this output when it observes that the arbiter of the same module is not operating correctly.

In the controller according to the invention, each module is the substitute for the other and the probability that the controller is unable to manage the bus access requests is very low since it corresponds to a simultaneous failure of both modules.

In a first embodiment of the invention, the two arbiters are synchronized by the same clock and deliver bus access authorizations simultaneously, the output of the two arbiters being combined by an or gate which delivers a single bus access authorization.

It is advantageous, in this embodiment, that each module includes its own clock and that a synchronization device external to the two modules synchronizes their two clocks.

In this case, it is the same synchronized clocks signal which is sent to both modules and to the bus, so that the bus read/write cycles coincide with the deliveries of access authorizations.

In a second embodiment of the invention, one of the two modules is predominant, its supervisor then fulfils an additional function consisting in disabling the output of the arbiter of the other module when it enables that of the arbiter of the same module.

In this case, the output of the second arbiter is routinely disabled as long as the first arbiter is operating correctly. It is enabled only when the first arbiter is no longer operating.

In a preferred embodiment of the invention, each module consisting of an arbiter and its supervisor is constructed in the form of a daughter card which can be inserted into and extracted from a mother card constituting, together with the two daughter cards, the bus controller according to the invention.

Given the manner of operation of the supervisor of the arbiter in each module, the hot insertion and extraction of a module can be achieved on the sole condition that the module which remains on the mother card is operational.

In a particular embodiment of the invention, the output signal generated by a supervisor so as to signal that the arbiter is operating correctly is a nonconstant signal, for example a square signal.

This arrangement makes it possible to discern a malfunctioning of the supervisor as soon as a constant signal is detected at its output, whether this signal be high or low.

The manner of operation of a controller according to the invention will now be described with reference to the appended figures in which:

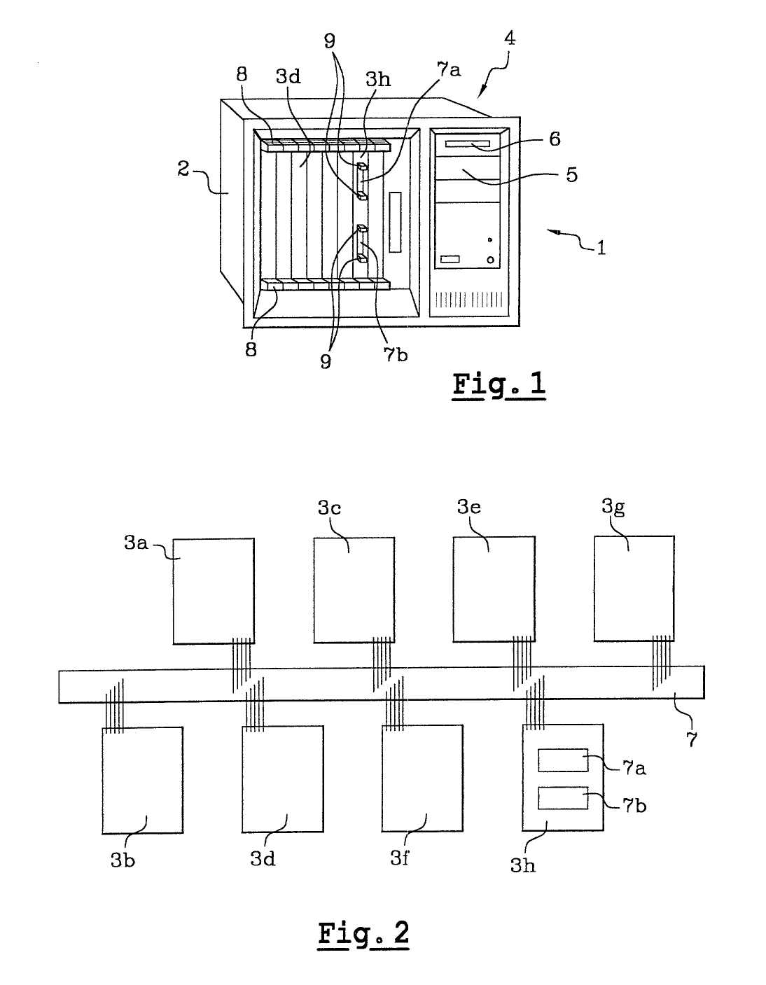

FIG. 1 is a perspective view of a cluster of computers using a bus arbitrated by a controller according to the invention,

FIG. 2 is a diagrammatic view of the architecture of the bus of the cluster of FIG. 1,

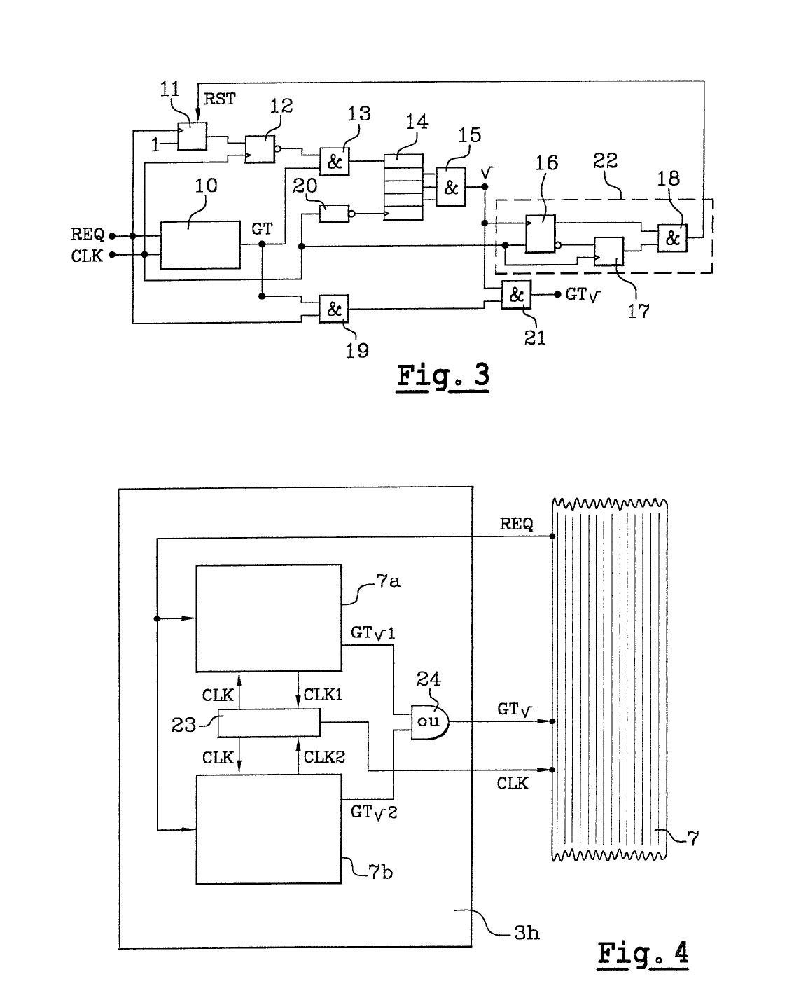

FIG. 3 is a schematic diagram of a module of a controller according to the invention,

FIG. 4 is a schematic diagram of a controller according to a first embodiment of the invention,

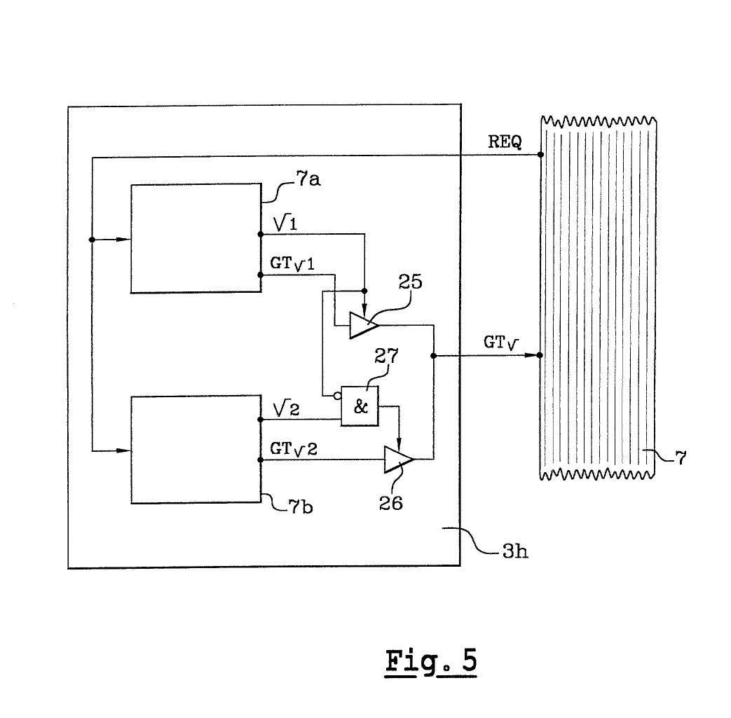

FIG. 5 is a schematic diagram of a controller according to a second embodiment of the invention.

The cluster of computers 1 represented in FIG. 1 comprises a box 2 of general parallelepipedal shape which contains eight removable cards 3a to 3h mounted on the box in such a way that each is slotted into a location of an internal bus 7 which can be seen in FIG. 2.

The box 2 also houses in a common part 4, a hard disk 5 and a removable disk drive 6.

The cards 3a to 3g are processor cards each constituting a computer of the cluster.

The card 3h is a bus controller card which supports two daughter cards 7a, 7b, each of which is removable with respect to the card 3h.

Locking tabs 8 are fitted to each of the processor cards 3a to 3h. Other locking tabs 9 are fitted to the daughter cards 7a and 7b.

In FIG. 2 may be seen the bus 7, on which are mounted the eight cards 3a to 3h, this latter being furnished with the two daughter cards 7a and 7b.

As is known in the case of a bus serving several masters, each of the processor cards 3a to 3g makes bus access requests REQ, which access requests are authorized by the controller card 3h as a function of the priorities assigned to each of the cards.

The overall manner of operation of the controller card is that of a conventional arbiter, that is to say that on receiving an access request REQ, the controller card delivers an authorization GT which allows the requesting master to monopolize the bus during a given period of time, after which it releases the bus.

However, unlike a traditional arbiter, the controller card of the described device here contains two arbiter modules, embodied by the two daughter cards 7a and 7b, each of which modules consists of an arbiter and an arbiter supervisor.

The structure of a module is provided in FIG. 3, in which it may be seen that at input, the module receives the access requests REQ and clock pulses CLK and that at output, the module delivers a verified access authorization GTV.

The module houses a traditional arbiter 10 which accepts at input the access requests REQ and delivers at output access authorizations GT.

The other components of the module make up the arbiter supervisor, which verifies the proper operation of the arbiter 10 and enables the authorizations given by this arbiter. To this end, the module includes a bistable flip-flop 11, another bistable flip-flop 12, an [AND] gate 13, a shift register 14, an [AND] gate 15, a bistable flip-flop 16, a bistable flip-flop 17, an [AND] gate 18, an [AND] gate 19, an inverting gate 20 and an [AND] gate 21.

The manner of operation of this module will now be described.

On receiving an access request REQ, the arbiter delivers an authorization GT. The request REQ causes the bistable flip-flop 11 to toggle to a high value (or true value). This high value in turn causes the bistable flip-flop 12 to toggle upon the first clock pulse provided by the clock CLK. The output of this second bistable flip-flop 12 is inverted and sent to the [AND] gate 13 in combination with the authorization GT provided by the arbiter.

The output of this [AND] gate feeds the shift register 14.

A clock pulse is provided by the inverting gate 20 at the input of the shift register 14 so as to cause the shifting of the inputs in the register.

After four clock pulses, the three outputs of the register feeding the [AND] gate 15 enable the latter, thereby providing a high (or true) signal V indicating that, during at least four clock cycles, the arbiter has delivered an authorization GT following the request REQ.

This output V confirms the proper operation of the arbiter.

The enabling output is provided to the [AND] gate 21 which thus allows through the signal arising from the [AND] combination 19 of the access request REQ and of the authorization GT so as to provide an enabled access authorization GTv.

The arbiter enabling output signal V is also combined with the clock signals in a resetting subcircuit (delimited by a broken line 22) so as to provide, after a few clock pulses, a resetting signal RST for resetting the first bistable flip-flop 11 so that the enabling output V switches back to the low level.

The proper operation of the arbiter is thus supervised.

Represented in the embodiment of FIG. 4 are the two arbiter modules 7a, 7b, which operate in a symmetrical manner, each providing an access authorization on request from the controller cards.

Each arbiter module delivers a validated authorization for access GTv1 and GTv2 to the bus by applying the same rules to the access requests received REQ.

The manner of operation of the two arbiter modules is synchronized by a synchronization module 23 which forces the two internal clocks CLK1 and CLK2 of the two arbiter modules to operate at the same rate, by returning a common clock signal CLK to each module, which signal is also provided to the bus 7. The bus access authorizations GTv1 and GTv2 are consequently strictly identical when the two arbiter modules are operating correctly.

The two access authorization signals GTv1 and GTv2 are combined in an [OR] gate 24 delivering a single bus access authorization signal GTv.

If one of the two arbiters or arbiter supervisors becomes defective, the corresponding module ceases to deliver access authorizations and the corresponding signal GTᵥi is held at a low level (corresponding to the false logic value).

The structure of each arbiter module is such that any malfunctioning of the internal arbiter or of its supervisor causes the signal GTᵥi to be set to a low level.

The security of operation afforded by such a controller card stems from the fact that it is sufficient for just one of the two arbiter modules to be operating normally in order for the signal GTv to be provided at the output of the controller card.

The defective arbiter module signals itself to the maintenance operator by any means whatsoever, for example by virtue of a light-emitting diode placed on the facade of the card 7a or 7b.

The defective arbiter module can then be substituted without difficulty, given that the functioning arbiter module alone ensures delivery of the access authorizations GTv.

In the embodiment of FIG. 5, one 7a of the two arbiter modules is regarded as the main arbiter, the other 7b being regarded as the secondary arbiter.

The two arbiter modules are linked together by a logic circuit consisting of two filters 25, 26 and an [AND] gate 27:

As long as the main module 7a is operating correctly, the access authorization signal V2 delivered by the secondary module 7b is blocked and only the access authorization signal GTv1 originating from the main module reaches the bus.

If main module 7a ceases to operate normally, whether this be because of a malfunctioning of the arbiter or a failure of the supervisor, its enabling signal V1 becomes false, thereby blocking the signal GTᵥ1 for authorizing access to the bus and the bus access authorization output signal GTᵥ2 of the secondary module is activated.

In each of the above two embodiments, a particular variant may be applied, consisting in providing an enabling output V₁ in the form of a nonconstant signal, for example square, so as to guarantee that the proper operation of one of the two arbiter modules is not erroneously diagnosed on account of an accidental setting to the expected value of this enabling signal, given that it is rather improbable that a failure output signal will accidentally be nonconstant and still less probable that this nonconstant signal will be precisely the expected nonconstant signal.

As indicated in the general description, each of the arbiter modules is designed so as to be able to be hot extracted from the controller card, this being readily understood on account of the fact that the two arbiter modules are always ready to take over from one another.

The invention is in no way limited to the embodiments just described, which are provided merely by way of examples.

1. Bus controller for a bus (7) which can be used by several masters (3a-3g), characterized in that it comprises at least two modules (7a, 7b) each of which contains an arbiter (10) and an arbiter supervisor, the function of one at least of the arbiter supervisors being to enable the output (GT) of the arbiter of the same module as long as it observes that this arbiter is operating correctly and to disable this output when it observes that the arbiter of the same module is not operating correctly.

2. Bus controller according to claim 1, characterized in that the two arbiters are synchronized by the same clock (CLK) and deliver bus access authorizations (GTᵥ1, GTᵥ2) simultaneously, the output of the two arbiters being combined by an [or] gate (24) which delivers a single bus access authorization (GTᵥ).

3. Bus controller according to claim 2, characterized in that each module (7a, 7b) includes its own clock (CLK1, CLK2) and that a synchronization device (23) external to the two modules synchronizes their two clocks.

4. Bus controller according to any one of claims 1 to 3, characterized in that one (7a) of the two modules is predominant, its supervisor then fulfils an additional function consisting in disabling the output (GTᵥ2) of the arbiter of the other module (7b) when it enables that of the arbiter of the same module.

5. Bus controller according to any one of claims 1 to 4, characterized in that each module consisting of an arbiter and its supervisor is constructed in the form of a daughter card (7a, 7b) which can be inserted into and extracted from a mother card constituting, together with the two daughter cards, the bus controller according to the invention.

6. Bus controller according to any one of claims 1 to 5, characterized in that the output signal (V) generated by a supervisor so as to signal that the arbiter is operating correctly is a nonconstant signal, for example a square signal.
